(19) United States
(12) Patent Application Publication
(10) Pub. No.: US 2003/0035143 A1
(43) Pub. Date: Feb. 20, 2003

(54) Apparatus and process for digital tool recognition for print final processing or print further processing equipment

(76) Inventors: Gerhard Glemser, Stuttgart (DE); Jochen Graber, Bissingen (DE); Tilman Sommer, Esslingen (DE)

Correspondence Address: Kevin Leffel, Heidelberg Digital L.L.C., 2600 Manitou Road, Rochester, NY, 14624, US

(21) Appl. No.: 10/207,558

(22) Filed: Jul. 29, 2002

(30) Foreign Application Priority Data
Jul. 30, 2001 (DE) 101 37 165.9
Mar. 1, 2002 (DE) 102 09 090.4

(51) Int. Cl. B41F 1/00; G06F 15/00

(52) U.S. Cl. 358/1.16; 358/1.11

(57) ABSTRACT

A processing module and print material process and apparatus are provided. The processing module comprises at least one processing tool having at least one print material processing functionality, and at least one read and write data storage having data with at least one parameter that allows identification of the processing module.

### BACKGROUND

The invention relates to apparatus and processes for further processing and finishing a product from a print process.

Finish printed or unprinted print materials will in most cases be further processed after printing, for example the print materials will be cut, grooved, creased, folded, hole-punched, collated, bound, stapled, sewn or glued, just to list a few of the numerous print further processing and final processing procedures. In many cases, devices are used for this that can carry out one or more of these functions, for example a folding machine that folds individual sheets, grooves and cuts them.

What is desirable is a device with which a number of these operations can be carried out, for example an apparatus set up in a modular way in which at least one module can be used depending on the desired function, whereby each of the modules has a specific tool with which at least one further processing function can be carried out, for example cutting or hole punching.

Typically during a change in function in further processing equipment, a number of parameters must be adjusted in the further processing equipment for the new tool, so for example with a cutting tool, blade and stops have to be adjusted. With tools that operate with special precision, eccentricities of shafts or wear on them due to the work cycles that have run previously may have to be considered and the further processing equipment will have to be adjusted to this accordingly.

From the state of the art, several solutions are known for accelerating the process of setting up a new tool, automating it and/or simplifying it. JP63174733A suggests a tool recognition in a punching machine. In this process, a tool number is read from a new tool and tool information that is stored in an external memory is compared with it and displayed on a screen.

DE 100 07 126 A1 discloses a spindle for a tool machine with a data storage element. Operating and/or condition data regarding the spindles can be stored in this data storage element and can be read out without intervention into the machine control.

A coated roller with a microtransmitter having an alphanumeric code, which cannot be taken off the roller and is used as documentation of the roller age, is known from U.S. Pat. No. 6,110,085.

So-called plug & play cards or other external user devices are known from applications in the computer area, which are automatically recognized and can be initialized by the computer after installation.

### SUMMARY OF THE INVENTION

A processing module and print material process and apparatus are provided. The processing module comprises at least one processing tool having at least one print material processing functionality, and at least one read and write data storage having data with at least one parameter that allows identification of the processing module.

### BRIEF DESCRIPTION OF THE DRAWINGS

FIG. 1 presents a schematic perspective view of a preferred embodiment of an apparatus with several holding locations for a processing module according to one aspect of the invention.

FIG. 2 presents a schematic view of a processing module according to one aspect of the invention.

FIG. 3 presents a schematic representation of an example embodiment of a tool roller for a punching module.

FIG. 4a presents a schematic representation of an example embodiment of a tool roller for a cutting module.

FIG. 4b presents a schematic representation of an example embodiment of a tool roller for a cutting module for edge cutting for register sheets.

FIG. 5 presents a schematic representation of an example embodiment of a tool roller for an embossing module.

FIG. 6 presents a schematic representation of an example embodiment of a tool roller for a perforating module.

FIG. 7 presents a schematic representation of the pattern of holes on a print material with respect to the movement direction along a paper path.

FIG. 8 presents a schematic representation of the pattern of an even or odd number of holes on a print material with respect to the movement direction along a paper path.

### DETAILED DESCRIPTION

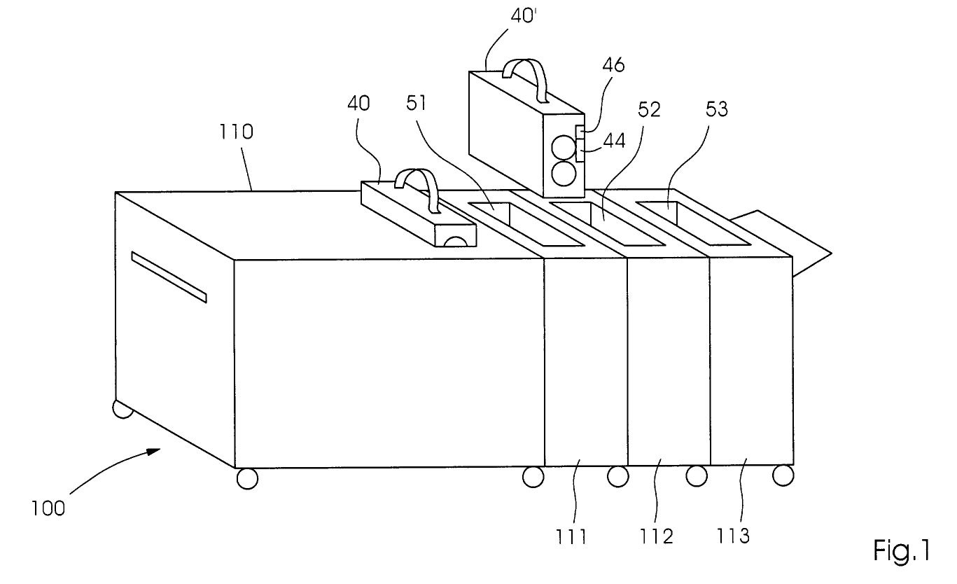

Various aspects of the invention are presented in FIGS. 1-8, which are not drawn to any particular scale, and wherein like components in the numerous views are numbered alike. Referring now specifically to FIG. 1, a modular apparatus, apparatus 100, for print materials 1, is presented, with several holding locations 51, 52, 53 for processing modules 40, 40′. Processing modules 40 according to the invention with specific processing modes are installed in the holding locations 51, 52, 53 provided for this and fastened there so that they can be removed, for example by clamping or by bolting or by using a suitable mechanism. The modular apparatus 100 can have an optional number of holding locations. The variation shown in FIG. 1 has the apparatus 100 and a housing 110 with a holding location for a processing module 40, 40′ in a holding location; however, additional processing modules 41′ can be used in additional housings 111, 112, 113 whereby the attachment of the additional housing functions according to the “plug and play” principle.

In this way, the size of the modular apparatus 100 can be adjusted to different requirements, depending on what is needed, say the requirements of a printing operation or a print further processing operation. The apparatus 100 could also already have several holding locations 51, 52, 53 in its housing 110.

For the apparatus 100, a large number of different operating modules 40 according to the invention with different processing tools 70, 80, 85, 90, 95 are available. In this process, the processing tools 70, 80, 85, 90, 95 can carry out at least one processing mode or, as also explained further below, sometimes a large number of different processing modes. It is also conceivable to mix processing modules 40, 40′ according to the invention that have a data storage element 46 with processing modules 40, 40′ that do not have the characteristics according to the invention within a modular apparatus 100, although exclusive use of processing modules 40, 40′ according to the invention is more advantageous.

A change between different processing modes is carried out on one hand automatically, if the processing modes between which a selection can be made can be carried out by the same processing module 40, or manually in that a processing module 40 with a first processing mode is replaced by another processing module 40′ with a second processing mode. Automatic replacement of processing modules 40, 40′ is also conceivable.

The replacement of a first and of a second processing module 40, 40′ is carried out by removing a detachable fastener between the first processing module 40 and the holding location 51, 52, 53, removal of the first processing module 40, installation of the second processing module 40′ in the holding location 51, 52, 53 that is now free and fastening the detachable fastener between processing module 40 and the holding location 51, 52, 53.

Mechanical and electrical data recording elements 44, as will be discussed more fully, come in contact with the processing module and the associated holding location 51, 52, 53 which for example insure the mechanical drive for the movements within the processing module 40, 40′ from the apparatus 100 to the processing module 40, 40′ according to the invention, and make possible the transfer of electrical control signals.

If several holding locations 51, 52, 53 are available, a change in the processing modes from processing modules 40, 40′ already in use in holding locations 51, 52, 53 can also be carried out in that the processing module 40 is changed from an active operation with the first processing mode to a bypass operation and a second processing module 40′, which until then had been in bypass operation, is switched over to active operation. This switching can be controlled both manually as well as with electronic control by way of the data recording elements 44 of the processing module 40, 40′ and the associated holding location 51, 52, 53 with a suitable machine control of the apparatus 100 known to the person skilled in the art.

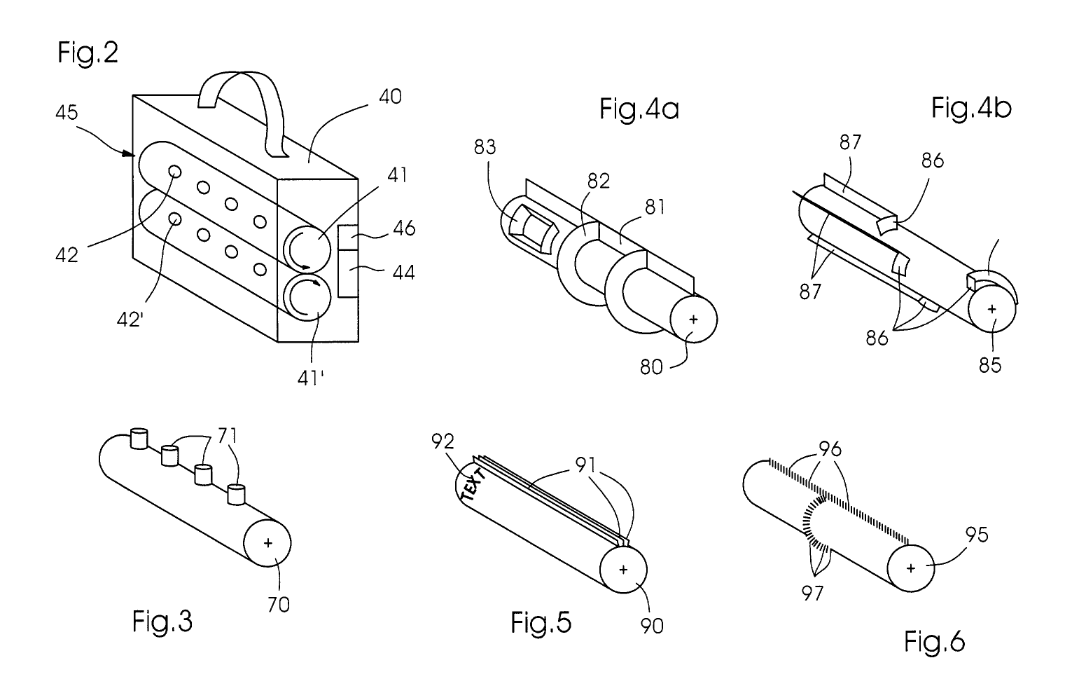

Data, for example operating parameters for the processing module 40, 40′, which among other things reflect the functionality or the processing mode/the processing modes of the processing module 40, 40′ are read out by the machine control when the new processing module 40, 40′ is installed in one of the holding locations 51, 52, 53. According to the data read in, the processing module 40, 40′ is identified and the apparatus is adjusted to it. The data that have been prepared from the data storage element 46 of the processing module 40, 40′ may be displayed on a display means that is not shown, e.g. a screen or other optical or acoustic display means. These data, which are displayed to a user by means of suitable display means, can comprise the following, among other things: serial number of the processing module, number and listing of the processing modes that can be carried out with the processing module 40, 40′, processing cycles of all the processing tools 45 that have already been carried out (see FIG. 2) of the processing module 40, 40′, manufacturing date, manufacturing tolerances, selection of different print materials 1 that the processing module 40, 40′ can process, especially by input of ranges with respect to permissible dimensions of the print material, e.g. A5 to A3, permissible weight of the print material and permissible materials for the print material, e.g. film, paper, etc. Because of this, the user is able to determine in a simple way whether the further processing method desired can be carried out by the current configuration of the apparatus 100. If desired, a check like this can also be carried out automatically, if for example the apparatus 100 contains data with respect to a print request from a preceding print machine. In this case, the parameters that are used for identification, initializing and operation of the processing module 40, 40′ can also be passed on to an upstream or higher level control (not shown, known to the person skilled in the art) and managed there.

It is also possible that a higher order control that processes a print request and/or a further processing request displays to a user, using display means that are not shown in the drawings, which processing module or which processing modules in the apparatus have to be used in order to be able to carry out the print request. In this case, the data that are stored in the data storage element 46 in the processing module 40, 40′ can especially advantageously be used for the higher order control to automatically determine whether the required processing module 40, 40′ was actually installed in the apparatus 100.

This is especially advantageous in the configuration of the apparatus in which a selection can be made from a large number of different processing functions, for example because of the presence of several processing modes in one processing module used 40, 40′ or the possibility of automatic change between different processing modules or automatic switch of one processing module from active operation to bypass operation or vice versa.

In this case, because of the possibility of communication between a higher level control with the processing module 40, 40′ or the processing modules 40, 40′, an automatic configuration of the apparatus can be carried out especially efficiently and quickly without the necessity of intervention by a user or the change between different processing modes.

Other information that can be stored in the data storage element 46 include manufacturer data, which in some cases can be stored in encrypted form. These manufacturer data could include for example detailed information for maintenance personnel, especially also about the use of the processing module, and in the case of a defective processing module could additionally provide help through stored diagnosis data. It is also conceivable that the manufacturer data could be called up during the initializing of the processing module 40, 40′ and only then permit a complete initializing if for example a secret manufacturer code was entered.

The structure of a processing module 40 is shown schematically in FIG. 2. According to the invention, the processing module 40 is equipped with a two-part rotary processing tool 45. For this, two cylindrical opposing rollers 41, 41′ are mounted within the processing module 40, a tool roller 41 and a die roller 41′ that carry out synchronized movements, e.g. through a coupling by means of a transmission or a toothed or V belt or other coupling mechanisms known to the person skilled in the art. The upper processing tool 41 holds tool elements 42, 71, 71, 82, 83, 86, 87, 91, 92, 96, 97, depending on the processing mode of processing module 40. These tool elements 42, 71, 82, 83, 86, 87, 91, 92, 96, 97 extend over the circumference of the tool roller and because of this, during rotary movement of the upper processing tool, dip into the plane in which the print materials 1 move, whereby the processing for print materials 1 is achieved.

The lower processing tool has dies 42′ that correspond to the respective tool elements 42, 71, 71, 82, 83, 86, 87, 91, 92, 96, 97 of the upper processing tool 41 and are in engagement with these tool elements 42, 71, 71, 82, 83, 86, 87, 91, 92, 96, 97 for processing a print material that runs through while rollers 41, 41′ are rotating. Because the die roller 41′ is in continuous working connection with the tool roller 41, and is replaced along with the tool roller 41 during replacement of processing the modules 40, 40′, the time-consuming adjustment between the two rollers 41, 41′ is eliminated, which otherwise would have had to be carried out each time there was a change.

Examples of different tool rollers 41, 70, 80, 85, 90, 95 for different processing modules 40, 40′ are shown in FIG. 3 to FIG. 6. In the processing module 40 shown in FIG. 3 for punching holes in print materials 1, for example for filing in binders or for preparation for subsequent wire comb, ring or spiral binding, the upper processing tool 41 is a punching tool 70. In it, radially on the circumference of the punching tool 70 there are punching elements 71. A change between different punching patterns is possible by the radial recessing of the upper dies around the circumference of punching tool 70.

In the processing tool 40 shown in FIG. 4a for cutting print materials 1, the tool roller 41 is a cutting tool 80. In it, radially around the circumference of the cutting tool 80 there are transverse cutting elements 81 and/or longitudinal cutting elements 82, e.g. for reducing the format or edge trimming and/or cutting elements 83 for producing windows or other shapes in a print material 1, as they are often placed e.g. in the covers of so-called soft cover books.

FIG. 4b shows a processing tool 85 for producing edge trimming for tabs. In this case, one of the cutter 87 is aligned essentially parallel to the page edge into which the tab will be brought. At least one second cutter 86 cuts perpendicular to this and carries out a complete separation of superfluous material. Also, cutters having corresponding geometries are possible for a semi-circular or other shaped edge cut for tabs.

In the processing module 40 shown in FIG. 5 for embossing print materials 1, the tool roller 41 is an embossing tool 90. In this case, embossing grooves 91 are found radially around the circumference of the embossing tool 90 which can run, for example, axially or in circumference direction and/or upper dies for embossing inscriptions 92 or emblems, logos or other things.

In the processing module 40 shown in FIG. 6 for perforating print materials 1, the tool roller 41 is a perforating tool 95. In this case, perforating needles are found radially around the circumference of the perforating tool 95, for example for corresponding production of tearaway edges in a print material.

The data recording element 44 in FIG. 2 can be for example a standard commercial RS232/RS485 interface known to the person skilled in the art. A contactless data recording element 44 is also possible, for example an infrared or radio signal interface. Also, an optical data recording element 44 is possible in which the data are transferred by way of a fiber optic connection between holding location 51, 52, 53 and processing module 40, 40′. The data storage element 46 is only indicated in FIG. 1 and FIG. 2 on the outside wall of the processing module 40, 40′ for clarity. It is clear to the person skilled in the art that the data storage element 46 is typically mounted on the inside of a housing, whereby with suitable wiring the position of the data storage element 46 in the processing module is irrelevant.

In the following, a particularly preferred embodiment of a processing module will be discussed, namely a processing module 40, 40′ according to the invention for generating specific hole patterns, LU, LG (FIG. 8) in a print material 1 and the compression of the information regarding the hole patterns LU, LG on a data storage element 46.

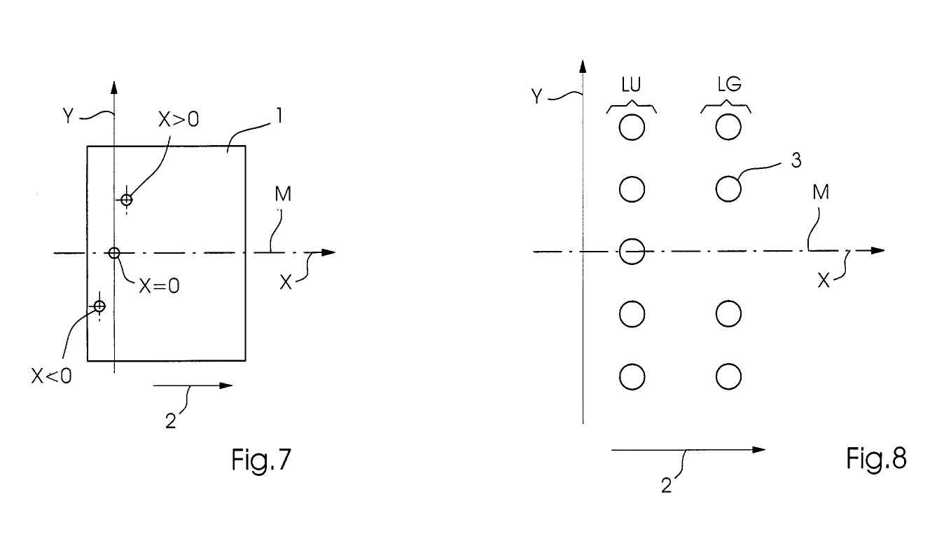

FIG. 7 shows schematically a sheet-shaped print material 1 with a number of holes 3. Reference character 2 indicates an arrow that specifies the movement direction of a sheet-shaped print material through the apparatus 100 and specifies the direction of an x-axis and, perpendicular to this, the y-axis of a Cartesian coordinate system.

Usually a hole pattern LU, LG consists of a number of holes that are arranged essentially on an imaginary line parallel to the y-axis. The origin of the coordinate system results through the point of intersection between this imaginary line and the center line M. Starting from this origin, the x and y positions of the individual holes 3 of the hole pattern LU, LG are measured.

The vast majority of standard hole patterns LU, LG have a symmetrical arrangement to the center line M. As shown in FIG. 8, these can be differentiated into even number hole patterns LG and odd number hole patterns LU.

Standard hole patterns include the international 2-hole pattern, the Japanese 2-hole pattern, the German 2-hole pattern, the US 3-hole pattern, the Japanese 3-hole pattern, and the German 4-hole pattern. What these patterns have in common is that they are symmetrical to the center line M, the holes 3 have the same distance from each other, all holes 3 of the hole pattern have the same shape (e.g. round or rectangular) and the same dimensions (diameter, length and width) and it is a matter of only a single row of holes. In this first case, it is adequate to specify the following data when storing the position of all the holes 3 of the hole pattern involved: number of holes, X and Y dimensions of a hole 3 or accordingly its diameter and distance of the first hole 3 to the center line M. For an odd number of holes 3, the center hole necessarily lies on the center line. In the case of ring bindings, comb bindings or spiral bindings, the hole pattern LU, LG also falls into this group.

For standard hole patterns like the US 5-hole pattern, the Swedish standard hole pattern and the Bell/AT&T 7-hole pattern, the holes 3 are arranged symmetrically to the center line M, all holes 3 of the hole pattern have the same shape (e.g. round or rectangular) and the same dimensions (diameter, length and width), it is a matter of only a single row of holes 3, but the holes 3 have different distances from each other. In the second case, it is enough to store the following data of the position of all holes 3 of the hole pattern LU, LG involved: number of holes, X and Y dimensions of a hole 3 or accordingly its diameter, distance of each hole 3 from the center line M with a y-position having y>0. Because of the symmetry of the hole pattern, the position of the holes y<0 results for the other half of the holes. For an odd number of holes 3, the center hole necessarily lies on the center line.

Numerous variations and modifications of the invention are evident in light of the description provided herein.

A processing module may be used within an apparatus for print materials having at least one processing tool mounted in the processing module whereby the processing tool has at least one processing functionality and at least one data storage element for storing data and at least one data recording element for reading out and/or reading in data in the data storage element, whereby at least part of the data are parameters that allow unambiguous identification of the processing module. The processing functionalities or processing modes of the processing tool involve e.g. the functions of cutting, punching, perforating, folding, embossing, grooving, gluing or printing a print material. In this process, a processing tool can advantageously also have several functionalities or processing modes, for example hole punching with different hole patterns, say 2-hole or 4-hole patterns.

During the change in a processing module of an apparatus that is configured so that it can hold processing modules, relevant parameters may be read out from the data storage element in the processing module by way of the data recording element, these data identifying the processing module and displaying to a user, for example using suitable display means and software, which functionality the processing tool has that is currently located in the further processing equipment. Also, data can be stored regarding the expected remaining service life of the processing tool or the processing module and if necessary can be displayed.

Parameters for identification may be stored in a nonvolatile memory. The data storage element may also have a write/read memory in which for example during operation of the processing module data can be recorded, in particular counter values that store the number of cycles carried out by the processing tool or the date of the last use or maintenance of the processing tool and/or the processing module or the respective number of cycles per processing tool for a case in which the processing module has a number of processing tools.

Data in the data storage element may be stored in compressed form. This is especially advantageous for storage of hole patterns for a punching tool. In this process, for precise identification of a hole pattern, data is necessary for each individual hole with respect to its position on the print material, the shape, for example round or square, the diameter and the number of holes in the hole pattern. With many frequently used hole patterns, e.g. international 2-hole pattern, Japanese 2-hole pattern, German 2-hole pattern, US 3-hole pattern, Japanese 3-hole pattern, German 4-hole pattern, US 5-hole pattern, Swedish standard hole pattern, Bell/AT&T 7-hole pattern, and hole patterns for ring/comb/spiral binding that have a specific number of holes, whose number of holes essentially depends on the dimensions of the print materials to be bound, these data that describe the individual holes are redundant. So by reference to the information that is used to identify a first hole, like its size, shape and distance from the side of a print material, redundant information can be avoided. It is also possible to utilize the usually constant spacing of the holes in the named hole patterns in order to determine the calculation of other holes iteratively using the position of a first hole, by specification of this value. In this way, the data stored in the processing module can be compressed.

Data stored in the data storage element may comprise at least one of the following: manufacturing date; serial number; function of the processing module and number of processing functions.

The processing module may be a punching module that operates in rotation with a punch shaft and a die shaft. Advantageously in this case, the data that are stored in the data storage element comprise data with respect to at least one of the following: number of possible hole patterns with the processing tool; number of upper dies in the processing tool; position of the upper dies in the processing tool; size and shape of the individual upper dies.

The apparatus may have a holding location for a processing module according to the preceding description whereby the holding location has a data recording element, which with the data recording element of the processing module, allows data transfer between apparatus and processing module.

The apparatus may have a control that participates in identifying a processing module that is used for the first time in the holding location, and initializing it using the data recording means with the help of the data stored in the data memory.

In the scope of the inventive concept on which the invention is based, the invention also comprises a method for initializing and for data transfer between a flexible modular apparatus and a processing module used in it for print materials by the apparatus described above or advantageous further developments.

Although the invention has been described and illustrated with reference to specific illustrative embodiments thereof, it is not intended that the invention be limited to those illustrative embodiments. Those skilled in the art will recognize that variations and modifications can be made without departing from the true scope and spirit of the invention as defined by the claims that follow. It is therefore intended to include within the invention all such variations and modifications as fall within the scope of the appended claims and equivalents thereof.

What is claimed is:

1. A processing module for an apparatus for processing print materials comprising at least one processing tool having at least one print material processing functionality, and at least one read and write data storage having data with at least one parameter that allows identification of the processing module.

2. The module of claim 1, wherein said data storage element is a nonvolatile memory.

3. The module of claim 1, wherein said data is compressed.

4. The module of claim 1, wherein said data includes information chosen from a group consisting of print material processing functionality, manufacturing date, serial number, and number of processing functions.

5. The module of claim 1, wherein said data includes information chosen from a group consisting of a number of processing cycles per processing function, and a number of processing cycles of said processing module.

6. The module of claim 1, wherein said processing tool includes a rotary-operating punching tool.

7. The module of claim 6, wherein said data includes information chosen from a group consisting of a number of possible hole patterns with said punching tool, a number of punches in the said punching tool, a position of a punch in said punching tool, and size and shape of an individual punch.

8. An apparatus for processing print materials, comprising:
a holding location that receives a processing module of a type having at least one print material processing tool, and at least one read and write data storage having data with at least one parameter that identifies said print material processing tool.

9. The apparatus according of claim 8, further comprising a control that recognizes said module using said data.

10. A print material process, comprising:
identifying a print material processing functionality of a processing module installed in a holding location in a print processing apparatus using data stored in at least one read and write data storage on said processing module.

11. The process of claim 10, wherein said data storage element is a nonvolatile memory.

12. The process of claim 10, further comprising compressing said data.

13. The process of claim 10, wherein said data includes information chosen from a group consisting of print material processing functionality, manufacturing date, serial number, and number of processing functions.

14. The process of claim 10, wherein said data includes information chosen from a group consisting of a number of processing cycles per processing function, and a number of processing cycles of said processing module.

15. The process of claim 10, wherein said processing tool includes a punching tool, and further comprising punching said print material with said punching tool.

16. The module of claim 15, wherein said data includes information chosen from a group consisting of a number of possible hole patterns with said punching tool, a number of punches in the said punching tool, a position of a punch in said punching tool, and size and shape of an individual punch.

17. The process of claim 10, wherein said processing tool includes a cutting tool, and further comprising cutting said print material with said cutting tool.

18. The process of claim 10, wherein said processing tool includes a perforating tool, and further comprising perforating said print material with said perforating tool.

19. The process of claim 10, wherein said processing tool includes an embossing tool, and further comprising embossing said print material with said embossing tool.

20. The process of claim 10, wherein said processing tool includes a tab cutting tool, and further comprising cutting a tab in said print material with said tab cutting tool.
